(19) United States
(12) Patent Application Publication
(10) Pub. No.: US 2019/0035039 A1
(43) Pub. Date: Jan. 31, 2019

(54) Dynamic balance adjustment method

(71) Applicant: Thomas T. Brekka, Santa Cruz, CA (US)

(72) Inventor: Thomas T. Brekka, Santa Cruz, CA (US)

(73) Assignee: VestaCare, Inc., La Jolla, CA (US)

(21) Appl. No.: 15/731,777

(22) Filed: Jul. 31, 2017

(51) Int. Cl. G06Q 50/22; G06Q 20/24; G06Q 20/38

(52) U.S. Cl. CPC G06Q 50/22; G06Q 20/38; G06Q 20/24

(57) ABSTRACT

A method for performing and implementing dynamic balance adjustment to reconcile a host hospital or medical provider's patient accounting systems with an automated payment plan management accounting system. The method utilizes initial estimates of patient financial liability, structured under a timed payment program, which is then adjusted to reflect the final balance owed after the other provider processes related to the insurance claim processing have been completed. This enables the provider to secure the patient's commitment for all future payment liabilities at the time of treatment or before.

### BACKGROUND OF THE INVENTION

### Technical Field

This invention relates to methods for performing dynamic balance adjustments to reconcile a host hospital or medical provider's patient accounting systems with an automated payment plan management accounting system.

### Background Art

Heretofore, numerous accounting systems and methods have been applied and used by hospitals and medical providers. Various methods have been proposed and implemented for hospital and medical provider's billing and accounting procedures. Although prior methods have been adapted and used, applicant is not aware of any method specifically for performing dynamic balance adjustments to reconcile a host hospital or medical provider's patient accounting systems with an automated payment plan management accounting system. The present methodology provides, for the first time, a method for performing dynamic balance adjustment to reconcile the host hospital or medical provider's patient accounting systems with an automated payment plan management accounting system.

A primary purpose of the present invention is to provide a method to enable the ability to work from an initial estimates of patient financial liability, structured under a timed payment program, which is then adjusted to reflect the final balance owed after the other provider processes related to the insurance claim processing have been completed. This allows the provider through the use of the present methodology to secure the patient's commitment for all future payment liabilities at the time of treatment or before.

In most cases the exact amount owed for the majority of patient liabilities for treatments rendered by hospitals and other healthcare providers is not known at time of treatment. Therefore, it is not feasible to collect payment in full for those treatment costs while the patient is present. Further with rising healthcare costs and health plans requiring large patient deductibles, most patients are unable to afford the high cost of hospital treatments in one payment at time of service. Hence being able to provide the patients with an affordable monthly payment amount which they can manage within their personal budgets is of great importance in securing patient payment for all treatment financial liabilities.

The present methodology and system provide a means for setting up an automated payment plan that is based on an estimate of the patients expected financial liability at the time of treatment. This can only be managed economically if those payment plans are able to be adjusted automatically and dynamically as the insurance billing cycle is completed by the hospital billing organization and appropriate changes updated in the hospitals host patient accounting system.

The preferred method as described herein further provides for dynamic balance adjustment capability, which is enabled through a variety of daily file exchanges and processing algorithms, and is able to ensure that the patient financial accounting system used to manage the automatic payment plans, as well as the plans themselves, can be accurately adjusted after all billing and insurance processes have been completed. This ensures the patient pays only the exact amount owed. Further the auto pay plans, including timing and amount of payment are adjusted to reflect the final balance owed, either by extending or shortening the payment plan duration and adjusting the final payment transaction amount.

Accordingly, the primary object of the present invention is to provide a method and system for performing dynamic balance adjustments to reconcile a host hospital or medical provider's patient accounting systems with an automated payment plan management accounting system. The present method provides a means to characterize what kind of data is being provided for the account adjustment, interpreting that data, deciding when to apply that data, and then managing the timing of these events. As such, the reconciliations timing depends on the type of data and where it is occurring amongst a sequence of other data events.

Additional objects and advantages of the invention will be set forth in the description which follows, and in part will be obvious from the description, or may be learned by practice of the invention. The objects and advantages of the invention may be realized and obtained by means of the methods, instrumentalities, and combinations particularly pointed out in the appended claims.

### SUMMARY OF INVENTION

To achieve the foregoing objects, and in accordance with the purpose of the invention as embodied and broadly described herein, in a preferred embodiment, a dynamic balance adjustment method for performing dynamic balance adjustments to reconcile a host hospital or medical providers' patient accounting systems with an automated payment plan management accounting system is provided. The method comprises: obtaining data files from the host hospital billing system; extracting data from host hospital provided files and cross walking that data to format(s) usable by a reconciliation engine; identifying initial, interim, and final self pay balances for each patient claim; synchronizing patient account changes with patient records maintained in the system; managing fluctuations in the self-pay balance attributable to similar changes occurring within the client's host billing system; applying the changes in order, sequence, and association with specific line item charges included under each encounter; modifying the auto payment plan set up for the patient encounter at time of service to reflect new balances derived from the above-mentioned reconciliation steps; aggregating new treatment charges and adjustments under a pre-existing auto pay plan structure; obtaining advanced eligibility data, and posting automatically solutions for updating the client host billing system with payment and plan adjustment information.

### BRIEF DESCRIPTION OF DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a flow chart showing the method and system for performing dynamic balance adjustments to reconcile a host hospital or medical provider's patient accounting systems with an automated payment plan management accounting system, according to the invention.

FIG. 2 is a flow diagram of a preferred method of receiving data files from a hospital and their processing, according to the invention.

FIG. 3 is a flow diagram of a preferred method of receiving HL7 ADT messages from a hospitals system to synchronize patient demographics, according to the invention.

FIG. 4 is a flow diagram of a preferred method of automatically adjusting a patient payment plan, according to the invention

FIG. 5 shows a data retrieval process using APA robotic engine, according to the invention.

### DETAILED DESCRIPTION OF THE PREFERRED EMBODIMENT

Reference will now be made in detail to the present preferred embodiments of the invention as illustrated in the accompanying drawings.

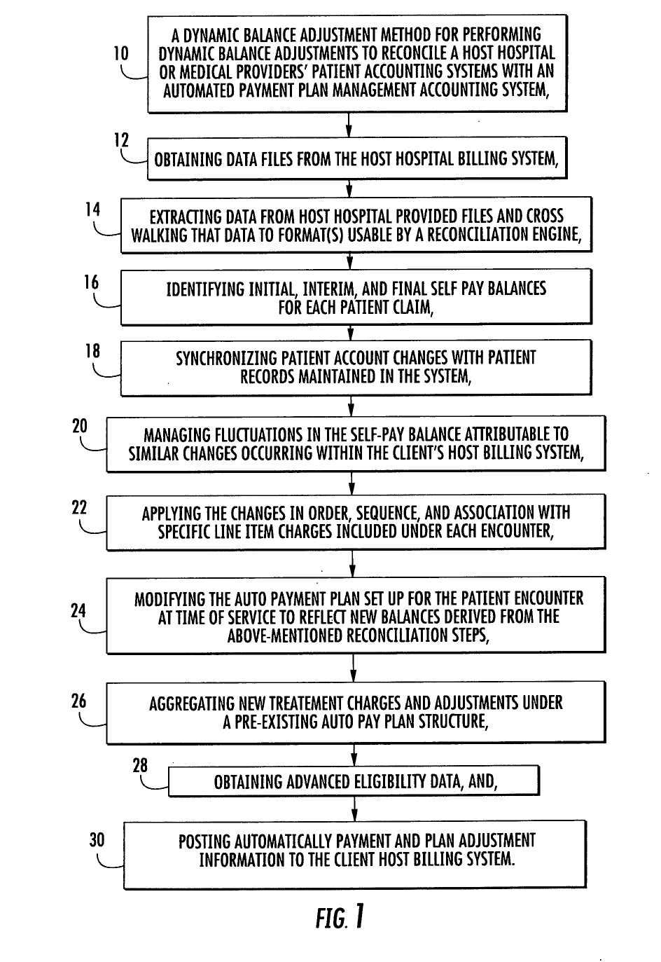

In accordance with the present invention, as seen in FIG. 1, there is provided in a preferred embodiment of the invention, a dynamic balance adjustment method for performing dynamic balance adjustments to reconcile a host hospital or medical provider's patient accounting systems with an automated payment plan management accounting method and system, 10.

Preferably, the method comprises: obtaining data files from the host hospital billing system, 12; extracting data from host hospital provided files and cross walking that data to format(s) usable by a reconciliation engine, 14; identifying initial, interim, and final self pay balances for each patient claim, 16; synchronizing patient account changes with patient records maintained in the system, 18; managing fluctuations in the self-pay balance attributable to similar changes occurring within the client's host billing system, 20; applying the changes in order, sequence, and association with specific line item charges included under each encounter, 22; modifying the auto payment plan set up for the patient encounter at time of service to reflect new balances derived from the above-mentioned reconciliation steps, 24; aggregating new treatment charges and adjustments under a pre-existing auto pay plan structure, 26; obtaining advanced eligibility data, 28: and posting automatically solutions for updating the client host billing system with payment and plan adjustment information, 30. Preferably the method for obtaining data files from the host hospital billing system 12, of the present invention supports two main data transfer protocols: HL7 (Health Level 7) and batch files. Preferably, HL7 protocols are utilized, as it provides almost real-time communication between the host hospital billing system and the present methodology. In the situation where the hospital system cannot afford or otherwise to provide for full HL7 capability, the present method allows for receiving data through batch files via FTP (File Transfer Protocol), or via CSV (Comma Separated Values), Excel and other file types. The present method is able to run several channels in parallel to handle the load and process incoming data whether from HL7 or batch files. In addition, an APA (Automatic Posting Application) robotic tool can be used for data extraction by interacting directly with the host hospital billing system. Preferably, an APA (Automatic Posting Application) robotic engine is used whenever some data cannot be exported into files from the hospital system for some reason or the export operation cannot be automated. APA uses native text extraction methods or OCR (Optical Character Recognition) to read the data directly from the hospital system and send it via a secure channel to the present methodology for reconciliation and storage. Using any combination of these methods, the present method 10, integrates seamlessly with the hospital billing system and receives any updates related to patient demographics, appointments, charges, collections, final bill indicators, bad debt status, and the like.

As seen in FIG. 1, the method for extracting data from the host hospital provided files 14, and cross walking that data to format(s) usable by the reconciliation Engine is shown. The present methodology uses HL7, batch files, APA robotic engine, or any combination of these methods to receive the updates from the host hospital system. The data received could be new data that was just added to the hospital system and do not exist yet in method, 10. It could also be modifications/adjustments that need to be applied to existing data in the present method.

Preferably, for each data transfer method in 14, the present methodology uses a different algorithm to parse and read the incoming data. The data passes through a validation layer that ensures the received data is correct. Different validation routines that check data types, range constraints, format and other constraints are applied. For, example: verifying required fields are not empty, specific data fields are received in the expected format like: date, SSN (Social Security Number), state, phone, zip code, email, and the like.

In step 14, of method 10, incoming data that fails the validation step is rejected from being saved in a data store and the client is notified in order to make the necessary corrections and resend the data again. Data that passes the validation step is transformed and populated in a data model that is passed to the reconciliation engine. The reconciliation engine identifies which data are new to the system and inserts them directly. For the data that already exists in the system, a matching algorithm is used to lookup the corresponding data model in 10, and updates it accordingly to make it synchronized with that in the hospital system. For example, whenever a patient demographics update is received, the present methodology looks up the matching patient records using MRN (Medical Record Number) or account number which uniquely identifies the patient and then updates the data fields of that patient using the received data.

In step 16, of method 10, as seen in FIG. 1, preferably the system identifies initial, interim, and final self pay balances for each patient claim. Because of the dynamic balance adjustment capability of the present method, this allows the host, or client to work with rough initial estimate amounts and refine the auto payment plan to the exact amount owed by the patient when the insurance claim billing cycle has been completed. Preferably, the initial estimate is either entered manually into the system or selected based on the tiered pricing feature in the system. Tiered pricing creates a very simple, fast and effective method for generating estimations for patient responsibility based on client CDM (Change Description Master) and contracted rates per insurance carrier to average price points for services rendered. Preferably, in step 16, after the insurance claim billing cycle has been completed, the present methodology automatically updates the initial estimate that was set previously with the new patient balance amount. The new patient balance is calculated by deducting the total collections and payments from the total charges amount. Further the auto payment plan, of method 10, including timing and amount of payment are adjusted to reflect the final balance owed, either by extending or shortening the payment plan duration and adjusting the final payment transaction amount.

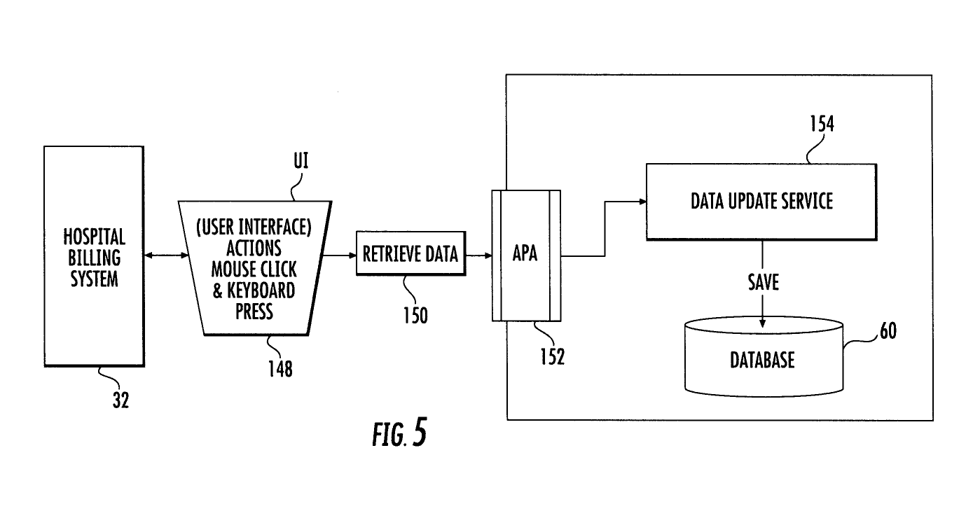

In step 18, of the preferred method 10, as seen in FIG. 1, account changes are synchronized with patient records maintained in the system. HL7 patient administration ADT (Admission, Discharge, Transfer) messages are used to exchange the patient state within a healthcare facility. The present methodology supports receiving HL7 ADT messages to keep its patient demographics and visit information synchronized with the hospital billing system. The ADT messages within the HL7 standard are used to exchange information such as which patient has been admitted, discharged, transferred, merged, demographics data has changed (name, insurance, address, and the like) or visit information has changed (for example, location). The present methodology reads the incoming HL7 ADT messages, extracts the needed information from them and use that information to locate the corresponding patient records in the system and updates them accordingly. The present method also provides alternative methods for receiving patient demographics updates in case the hospital system doesn't support HL7. It can receive the patient demographics updates via various files types like CSV, Excel, and the like. It can also use an APA robot to retrieve the data directly from the hospital system as shown in FIG. 5.

In FIG. 1 in step 20, a preferred method for dealing with fluctuations in the self-pay balance attributable to similar changes occurring within the client's, such as a hospital or medical provider's host billing system is shown. The preferred methodology supports receiving SP (Self Pay)) status updates from the clients host billing system through CSV files. Each row in the CSV file corresponds to a patient encounter/account that indicates when an encounter goes in or out of SP status. The patient encounter might switch from/to SP status several times. The present method uses those files to update the corresponding patient encounters in the present system to reflect the current SP status in the hospital system. Preferably, the present method SP monitor process monitors all patient accounts in the system that are in SP status. If 5 days elapsed since the encounter has entered the SP state, preferably, the present method runs a reconciliation process that calculates the new patient balance based on the total payments and total collections received in the system. The initial estimate that was set by the user manually in the system is then adjusted and the auto payment plan is re-constructed to accommodate the new patient balance. Additionally, the present methodology allows receiving SP updates using HL7 and APA robot as alternative methods to the SP CSV files. The appropriate method is used depending on the hospital system the present method is integrating with and its capabilities.

Next, in step 22, a preferred method for correctly applying the changes in order, sequence, and association with specific line item charges included under each encounter is shown. The present method preferably consolidates the data received from disparate data sources and in different formats into a data model that is saved in a single data storage. For each data source, a channel is setup in the system that handles the retrieval, parsing, validation, and storage of the data. Each channel can be customized to receive the data either in real-time mode or in batch mode on daily, weekly, semi-monthly or monthly basis depending on the data source itself. For example, HL7 channel can receive data in real-time. CSV file channel/receiver can receive files through FTP (File Transfer Protocol) server based on specific time schedules. One or multiple fields from the incoming data are preferably used to uniquely identify the corresponding data model in the system that needs to be updated. When receiving a charge or collection record from the hospital system, the preferred methodology is to extract encounter identifier from the incoming data and use it to locate corresponding encounter data model in the system and incorporate the received charge/collection under it. Preferably, the system is configured to react differently depending on the nature and the type of the data received. Some data types trigger the reconciliation engine to run immediately on the received data and its related patient/encounter data model in the system. This applies to receiving HL7 ADT messages where the reconciliation engine applies the necessary updates instantly to synchronize the corresponding patient information in the system with that in the hospital system. Other types of data, when received, are just stored in the system and their patient/encounter data will be reconciled at a later time. For, example when receiving SP status update, the corresponding encounter in the present methodology is updated with the new SP status however the reconciliation Engine preferably waits for 5 days before it calculates the new patient balance and subsequently adjusts the auto payment plan to accommodate the new balance. This means, that some data is marked as eligible for reconciliation upon receiving specific updates, occurrence of specific events or upon reaching specific date/time.

Next, the preferred method for modifying the auto payment plan is set up for the patient encounter at time of service to reflect new balances derived from the above-mentioned reconciliation steps, 24. The present method allows securing an auto payment plan based on an initial estimate that can be later adjusted dynamically and automatically. The estimate amount may cover partially or completely the total charges amount. The auto payment plan is adjusted automatically whenever a patient's transaction is received. If the transaction received is a payment or a negative adjustment, the balance is decreased and the auto payment plan is shortened by canceling some of the future scheduled payments, starting with the future most payments in the plan, to take out the difference. If the transaction received is a refund, a charge, or a positive adjustment, the balance is increased and the auto payment plan is extended by adding new future scheduled payments at the end of the plan to cover the added amount. In both cases, the monthly amount that the patient has agreed to pay is preserved. Preferably, if 5 days elapsed since the patient account went into the SP status, the system calculates the new patient balance by deducting the total collections and payments from the total charges amount. The new patient balance is then used and the auto payment plan is re-adjusted. However, in all cases, the system automatically adjusts the auto payment plan so that the patient only pays what he or she owes exactly.

In FIG. 1, step 26, shows the preferred method for aggregating new treatment charges and adjustments under a pre-existing auto pay plan structure. Preferably, step 26, includes, and as described above, an existing auto payment plan that is adjusted automatically whenever a patient's transaction is received. Transactions like a refund, charge, or positive adjustment yields to an increase in the patient balance and the auto payment plan is extended by adding future scheduled payments at the end of the plan. Transactions such as a payment or negative adjustment yields to a decrease in the patient balance and the auto payment plan is shortened by removing some of the future scheduled payments. At the same time, the system allows the user to re-construct the auto payment plan by adding additional charges manually. Further a new auto payment plan can be setup with the same credit card on file. This makes it very convenient for patients who are being checked in for multiple treatment steps, such as Labs, Radiology, Outpatient, Physical Therapy, and the like. Once they are setup in the present method and system all the rest of the visits would require only an acknowledgement from the patient authorizing adding the additional charges to their auto payment plan previously setup.

The present methodology reconciliation Engine at a top level and detail component level is herein described for a preferred embodiment of the invention. Preferably, the reconciliation engine of the present method consolidates the data received from different sources and in different format to be stored in method and system 10. The data reconciliation is based on a comparison between the incoming data and the application data in the method. It identifies if the incoming data is new, duplicate, or contains updates to data that is already present in the system. Part of the reconciliation process is to make the data in the system synchronized with that in the hospital billing system. This applies to patient demographics information, scheduled appointments, or patient transactions like charges, payments, collections, and the like. The reconciliation engine handles as well the re-calculation of the new patient balance. This is triggered by receiving a patient transaction from the hospital system or when a patient account enters the SP status. As described above, the new patient balance is preferably computed by deducting the total payments and total collections from the total charges amount. The new patient balance is then used to re-construct the auto payment plan which might be extended by adding more payments to it or shortened by canceling some of the scheduled payments to accommodate the new balance amount.

The preferred auto pay plan of the present method and system 10, is described herein at both a top level and detailed component level. The present methodology includes an auto payment plan system allows the provider to secure the patient's commitment for all future payment liabilities at the time of treatment or before. At the same time, it provides the patients with an affordable monthly payment amount which they can manage within their personal budgets. To create and setup an auto payment plan, it is preferably required that a credit card or a bank account (checking/saving) be provided. Payments can be scheduled to execute daily, weekly, semi-monthly and monthly, or as desired.

The preferred auto payment plan can be setup based on one or multiple patient encounters/visits where the total amount is calculated based on the selected encounters. An auto payment plan can start immediately, at specific date in the future or delayed. Delayed auto pay plan starts automatically after 120 days from DOS. If a patient transaction is received and the patient balance is changed, the auto payment plan is either extended by adding more payments at the end of the plan or shortened by canceling some scheduled payments to accommodate the new patient balance as explained previously. The same process repeats on every patient transaction received. It also runs if 5 days elapsed after the patient encounter entered into SP status. This is to maintain an accurate patient balance in the system and to ensure the patient pays the exact amount he owes.

With reference to FIG. 1, step 28, of the present method provides for obtaining advanced eligibility data which preferably comprises retrieving a patient eligibility and benefit information prior to the time of service. Information such as identity, coverage dates, copay, coinsurance, deductible, out of pocket max remaining amounts at both individual and family levels are obtained and saved in present method and system. The preferred methodology uses the EDI (Electronic Document Interchange) 270/271 standard as the main method for retrieving patient eligibility information. For each scheduled patient's appointment, the system preferably automatically generates an eligibility request in the form of EDI 270 and submits it to an eligibility verification third-party vendor which returns back an eligibility response in the form of EDI 271. If the EDI 270/271 cannot be used for some reason or if the data returned through this EDI standard is not sufficient, the present method and system 10, uses a robotic engine to retrieve the necessary additional eligibility information. This robotic engine interfaces with each individual payer website where it uses pre-provided credentials to login to the website, navigate through its pages, extracts the needed eligibility information and store them in the system.

In FIG. 1, step 30, the auto posting solution for updating the client hot billing system with payment and plan adjustment information is shown. The present method and system's integration with the host billing system is not limited to receiving data files. It also works in the other direction to post information entered into the system back to the client billing system. Data posting can be accomplished via HL7 or batch files. HL7 provides almost real time communication. Batch files via FTP are preferably used for bulk transfer of data. Further, APA robotic engine can be used to post data by interacting directly with the hospital billing system. Using any of these methods, the present method and system automatically posts back payments and refunds to adjust the balance in the hospital system. It also posts plan adjustment information, user entered notes, email/SMS notification messages, RFC letters statuses, and the like.

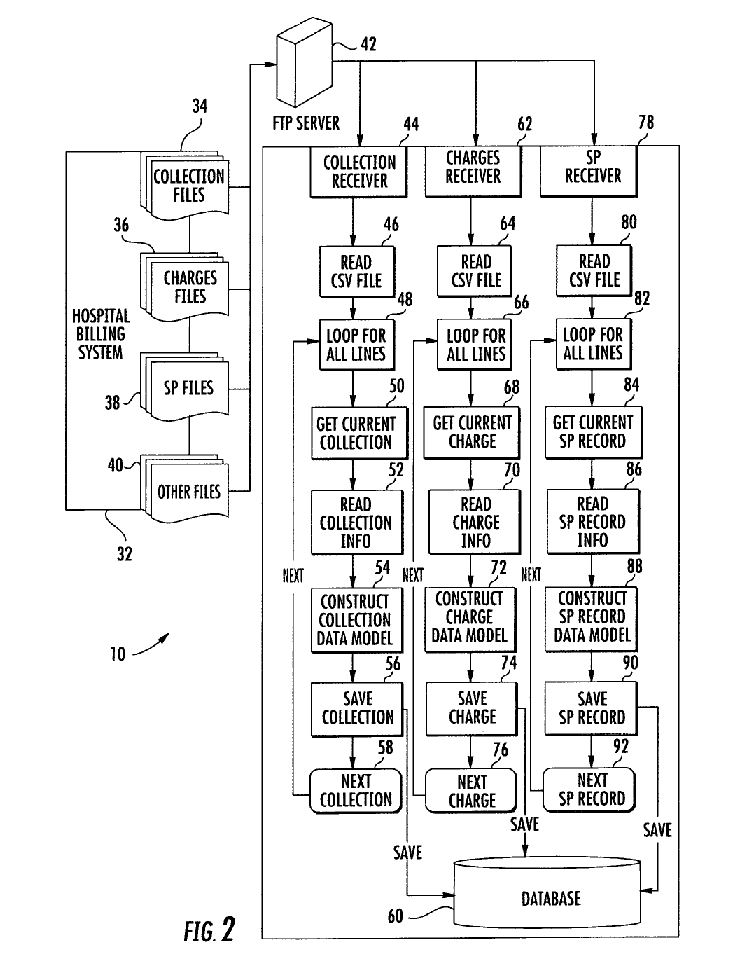

As seen in FIG. 2, a preferred method for receiving files from a hospital billing system 32, and processing them via data transfer to FTP (File Transfer Protocol) server 42 is shown, and steps 44-92 as illustrated described and then to database 60. From FTP server 42, data preferably goes via a collections receiver 44, to CSV (Comma Separated Value) file 46, to loop 48, current collection 50, read collection 52, construct collection data model 54, to save collection 56, to database 60. Next collection 58 to loop 48, for all lines.

In FIG. 2, from FTP server 42, data may also be fed into charges receiver 62, to CSV file 64, to loop all lines 66, to current charge 68, read current charge 70, to construct data model 72, to save charge 74, to database 60. Next charge 76, routed to loop for all lines 66. For SP (Self Pay) receiver 78, preferably data is routed to read CSV file 80, to loop 82, to get current SP record 84, to read SP 86, to construct SP record data model 88, to save SP record 90, to database 60. The next SP record 92, to loop 82, for all lines.

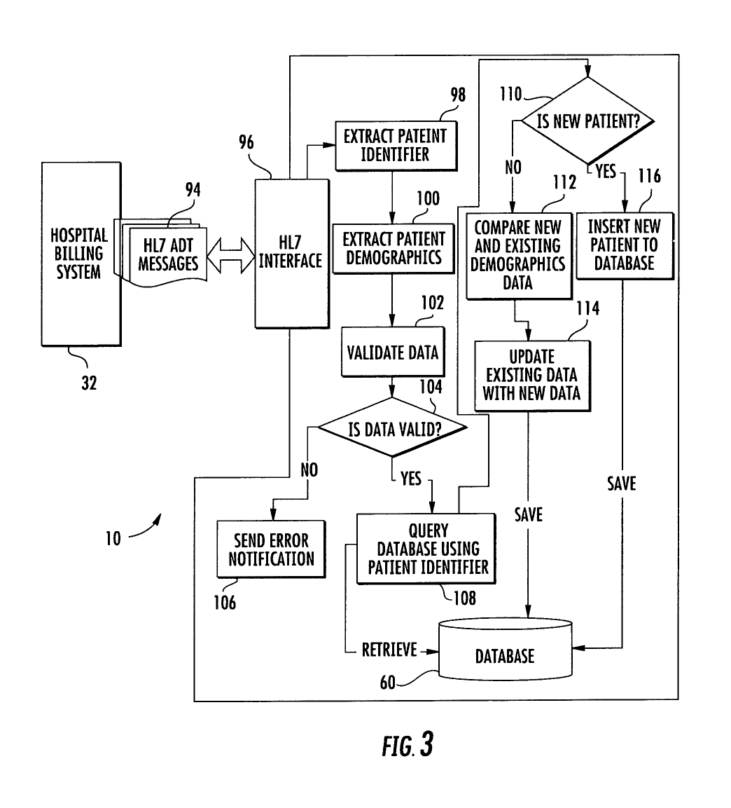

In FIG. 3. a preferred method for receiving HL7(Health Level 7) ADT (Admission, Discharge, Transfer) data and messages from a hospital system to synchronize patient data demographics in method 10, is shown. Preferably, HL7 ADT messages 94, are routed to HL7 interface 96, to patient identifier 98, to extract patient demographics 100, to validate data 102, and to data validity check 104. If the data is not valid, then a error notification is sent 106. If correct, then query database using a patient identifier 108, and then to database 60. Patient identifier 108, if recognizes a new patient 110, then route to insert new patient 116, and save into database 60. If an existing patient in the system, compare new and existing demographic data 112, and then update existing data with new data 114, and save to database 60.

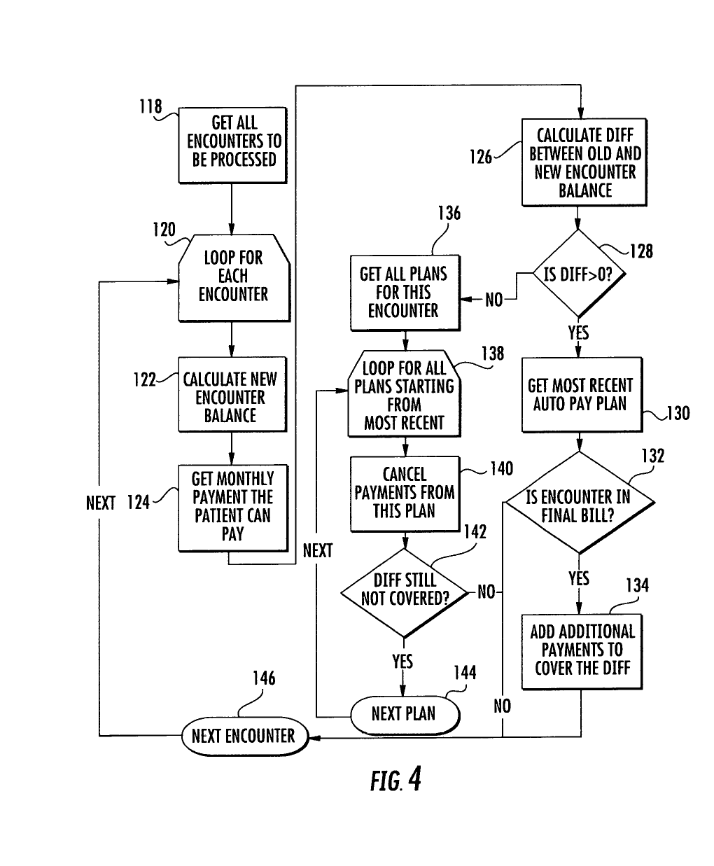

With reference now to FIG. 4, a preferred method for modifying or adjusting the auto payment plan set up for the patient is illustrated. First collect all encounters to be processed 118, loop each encounter 120, calculate new encounter balance 122, and then get the monthly payment that the patient can pay 124. Then the difference between the old and new balance calculated 126, and the determination if difference is greater than zero 128. If yes, the most recent payment plan 130, is retrieved and analyzed to see if encounter is in final bill 132. If yes, then additional payments are added to cover the difference 134. If difference between the old and new encounter balance 126, is not greater than zero, then all plans for the new encounter are collected 136, loop for all plans starting with the most recent 138, cancel payments from this plan 140, and if the difference is still not covered 142, then route to 146, if yes, then pass to next plan 144, and next encounter 146.

In FIG. 5, a data retrieval process using APA 152, is illustrated. APA is capable of interacting with the hospital system 32, and user interface 148, directly if it's installed on the same machine as the hospital system or remotely using a remote access software if it's installed on a different machine. Remote Desktop Protocol (RDP), Virtual Network Computing (VNC) or any other remote access software/protocol can be used by APA to interact remotely with the hospital system. In both cases, locally or remotely installed APA, it simulates mouse clicks and keyboard presses, to perform a certain operation. APA can identify screens, handle dialogs and popups, read data from labels, text fields, tables, and other controls on the screen. APA sends the data retrieved 150, from the hospital system 32, via a secure channel over the internet to the data update service 154, in the present methodology which in turn saves the data in the database, 60. The communication is preferably done over Hyper Text Transfer Protocol (HTTP) within a connection encrypted by Transport Layer Security (TLS).

In operation and use, the present method may be implemented through the operation of a computer, a central data processing unit, wireless communication channels, storage media, computer buses, or other data processing and transfer means well known in the art. Software, cloud computing, internet and other digital means may be utilized. The present invention provides a method and system for performing dynamic balance adjustments to reconcile a host hospital or medical provider's patient accounting systems with an automated payment plan management accounting system. The present method may also be used by a hospital billing system vendor within their own system, that is, not as an external system. The present method further provides a means to characterize what kind of data is being provided for the account adjustment, interpreting that data, deciding when to apply that data, and then managing the timing of these events. As such, the reconciliations timing depends on the type of data and where it is occurring amongst a sequence of other data events.

The present methodology provides a method using automated interfaces, such as HL7, FTP, CSV, or APA robot, for example, with pre-exisiting estimating solutions to ensure the contiguous, uninterrupted processing of a patient encounter through a complete workflow. The avoidance of duplicate data entry is crucial to ensuring staff can enroll patients in as short as time as possible. The present methodology provides a seamless, fully integrated patient encounter automated payment management solution. The broad library of sophisticated interface technologies allows the present method to connect any pre-existing tools a client has with the patient encounter workflow, making it seamless and very easy and efficient to use.

Additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A dynamic balance adjustment method for performing dynamic balance adjustments to reconcile a host hospital or medical provider's patient accounting systems with an automated payment plan management accounting system, comprising:
obtaining data files from the host hospital billing system,
extracting data from host hospital provided files and cross walking that data to format(s) usable by a reconciliation engine,
identifying initial, interim, and final self pay balances for each patient claim,
synchronizing patient account changes with patient records maintained in the system,
managing fluctuations in the self-pay balance attributable to similar changes occurring within the client's host billing system,
applying said changes in order, sequence, and association with specific line item charges included under each encounter,
modifying the auto payment plan set up for the patient encounter at time of service to reflect new balances derived from the above-mentioned reconciliation steps,
aggregating new treatment charges and adjustments under a pre-existing auto pay plan structure,
obtaining advanced eligibility data, and
posting automatically payment and plan adjustment information to the client host billing system.

2. The dynamic balance adjustment method of claim 1, wherein HL7 protocols are utilized for obtaining data from a host hospital billing system.

3. The dynamic balance adjustment method of claim 1, wherein batch file protocols are utilized for obtaining data from a host hospital billing system.

4. The dynamic balance adjustment method of claim 1, wherein an APA robotic tool is utilized for data extraction by interacting directly with a hospital billing system.

5. The dynamic balance adjustment method of claim 1, wherein self-pay status updates are received from a host billing system through CVS files.

6. The dynamic balance adjustment method of claim 1, wherein a robotic engine is used to retrieve eligibility data.

7. A method for dynamic balance accounting to characterize what kind of data is being provided for an account adjustment, interpreting that data, deciding when to apply that data, and then managing the timing of these events, so that the reconciliations timing depends on the type of data and where it is occurring amongst a sequence of other data events, comprising:
obtaining data files from a host billing system,
extracting data from the host system's provided files and cross walking that data to format(s) usable by a reconciliation engine,
identifying initial, interim, and final self pay balances for each claim,
synchronizing account changes with records maintained in the system,
managing fluctuations in the self-pay balance attributable to similar changes occurring within the host billing system,
applying said changes in order, sequence, and association with specific line item charges included under each encounter,
modifying the auto payment plan set up for the encounter at time of service to reflect new balances derived from the above-mentioned reconciliation steps,
aggregating new treatment charges and adjustments under a pre-existing auto pay plan structure,
obtaining advanced eligibility data, and
posting automatically payment and plan adjustment information to the client host billing system.

8. The method of claim 7, wherein HL7 protocols are utilized for obtaining data from a host billing system.

9. The method of claim 7, wherein batch file protocols are utilized for obtaining data from a host billing system.

10. The method of claim 7, wherein an APA robotic tool is utilized for data extraction by interacting directly with a host billing system.

11. The method of claim 7, wherein self-pay status updates are received from a host billing system through CVS files.

12. The method of claim 7, wherein a robotic engine is used to retrieve eligibility data.

13. A dynamic accounting method of controlling a payment plan in conjunction with changes in the status of a host patient accounting system records, so that external transactions performed by a patient and the payment vendor, allow for multiple inputs to a reconciliation engine, comprising:
obtaining data files from a host hospital billing system,
extracting data from host hospital provided files and cross walking that data to format(s) usable by the reconciliation engine,
identifying initial, interim, and final self pay balances for each patient claim,
synchronizing patient account changes with patient records maintained in the system,
managing fluctuations in the self-pay balance attributable to similar changes occurring within the client's host billing system,
applying said changes in order, sequence, and association with specific line item charges included under each encounter,
modifying the auto payment plan set up for the patient encounter at time of service to reflect new balances derived from the above-mentioned reconciliation steps,
aggregating new treatment charges and adjustments under a pre-existing auto pay plan structure,
obtaining advanced eligibility data, and
posting automatically payment and plan adjustment information to the client host billing system.

14. The dynamic balance adjustment method of claim 13, wherein HL7 protocols are utilized for obtaining data from a host hospital billing system.

15. The dynamic balance adjustment method of claim 13, wherein batch file protocols are utilized for obtaining data from a host hospital billing system.

16. The dynamic balance adjustment method of claim 13, wherein an APA robotic tool is utilized for data extraction by interacting directly with a hospital billing system.

17. The dynamic balance adjustment method of claim 13, wherein self-pay status updates are received from a host billing system through CVS files.

18. The dynamic balance adjustment method of claim 13, wherein a robotic engine is used to retrieve eligibility data.
